(19) United States
(12) Patent Application Publication
(10) Pub. No.: US 2005/0233750 A1
(43) Pub. Date: Oct. 20, 2005

(54) Method and system for modeling a telecommunication network

(76) Inventor: Giuseppe Pirrone, Naperville, IL (US)

Correspondence Address: Michael G. Fletcher;Fletcher Yoder, P.O. Box 692289, Houston, TX, 77269-2289, US

(21) Appl. No.: 10/827,488

(22) Filed: Apr. 19, 2004

(51) Int. Cl. H04Q 7/20

(52) U.S. Cl. 455/446

(57) ABSTRACT

A technique for modeling a telecommunication network, such as a network of processors employed in a mobile switching center (MSC), is described. The modeling technique may derive outputs, such as bandwidth utilization, message load distribution, and processor utilization. To derive these outputs, the modeling technique may be provided inputs, such as a call model, network configuration, MSC architecture, and processor-specific data. The input and outputs of the modeling technique may be provided by various interfaces, including a graphical user interface (GUI).

### BACKGROUND OF THE INVENTION

1. Field of the Invention

The present invention relates generally to telecommunication networks and, more particularly, to techniques for modeling the performance of a telecommunication network.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Over the past several decades, communications systems, including wire line and wireless communications systems, have steadily evolved. One example of this evolution is the continuing adoption and growing prevalence of cellular telephone systems. Similarly, other devices that utilize telecommunication resources, such as computers, fax machines, and PDA's, have become increasingly widespread. As the number and types of telecommunication devices has increased, greater demand has been placed on the telecommunication resources needed to support these increases, such as on the underlying public and private telecommunication infrastructure.

As a result of this demand, the efficient utilization of existing telecommunication resources has steadily increased in importance. Similarly, it is generally desirable to design new networks and/or to upgrade existing networks to achieve the desired benefits efficiently without wasting resources. Furthermore, as new telecommunication standards and network configurations are adopted, it may be desirable to connect existing and new networks together as seamlessly and effectively as possible.

It may be difficult, however, to readily ascertain the efficiency of different hardware and software configurations in new, existing, or mixed network environments. In particular, the number of variables involved, such as hardware specific factors, variables related to system usage, e.g., call patterns and call durations, and the desired level of redundancy, may preclude easily determining a suitable network configuration and/or allocation of resources. Furthermore, the number of nodes and/or processors associated with a large network environment may further increase the difficulty of determining efficient hardware and software configurations.

For example, the determination of a suitable network configuration may depend on the ability to estimate current and future network usage based on known or estimated customer call parameters. Similarly, the suitability of a network configuration may depend on the consequences of various failure conditions and the subsequent redistribution of traffic and processing loads on the network. In addition, it may be desirable to identify bottlenecks associated with different network configurations.

The various techniques used to assess the sufficiency and/or suitability of a network often have various drawbacks, however. For example, such techniques may not readily or easily support the number of processors found in a large network, such as the network associated with a mobile switching center, or the variety of load conditions of interest. Indeed, the techniques may only be useful for assessing or modeling a single component or processor in isolation, which may not be useful in determining the efficiency or sufficiency of the network as a whole. Furthermore, the wide array of information that may be of interest to an operator, such as processor cost, processor utilization, bandwidth utilization, and so forth, may not be readily available from a single, comprehensive source.

It may, therefore, be desirable to develop techniques that allow comprehensive and rapid evaluation of different network configurations, including evaluation of the constituent links and processors of the network, based on the range of variables that may affect network performance.

### SUMMARY OF THE INVENTION

Certain embodiments commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one embodiment of the present invention, there is provided a method for modeling a communication system. The method provides for the use of a call model, a network configuration, a network architecture, and processor specific data to generate data that may be used to assess the efficiency and/or sufficiency of the multiple processors and links comprising the network. In particular, utilization of multiple processors may be jointly determined from the model based on the inputs. Similarly, utilization of multiple links and link combinations may be jointly determined. In other embodiments, a tangible, machine readable media and a device are provided for implementing the present network modeling technique.

### BRIEF DESCRIPTION OF THE DRAWINGS

Advantages of the invention may become apparent upon reading the following detailed description and upon reference to the drawings in which:

FIG. 1 illustrates an exemplary embodiment of a network that may be modeled in accordance with the present technique;

FIG. 2 depicts a flowchart describing an exemplary modeling technique, in accordance with the present technique;

FIG. 3 illustrates an exemplary screen depicting a telecommunications network, in accordance with the present technique;

FIG. 4 illustrates an exemplary screen depicting the input of variables associated with a call model, in accordance with the present technique;

FIG. 5 illustrates an exemplary screen depicting the input of variables associated with a network component, in accordance with the present technique; and

FIG. 6 illustrates an exemplary screen depicting an analysis output, in accordance with the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The techniques disclosed herein may be useful in the design and/or evaluation of a various telecommunication networks, particularly those networks which incorporate large numbers of processors and associated links. Specifically, the techniques described herein provide for the development of models which may be used to assess the efficiency and/or sufficiency of multiple processors and/or links concurrently. Furthermore, factors such as hardware specific information, customer call models, network architecture, and other network configuration information may contribute to the model, allowing the effects of these factors to be observed across some or all of the modeled processors and links.

The modeling techniques may, therefore, be used to evaluate a network configuration under a variety of circumstances, such as under normal operation, peak operation, or various failure conditions. As a result, these techniques not only provide an approach to modeling a telecommunication network but also the capability to evaluate the suitability of various network configurations. Suitable configurations may then be used to design or upgrade a telecommunication facility or the network connections to such a facility.

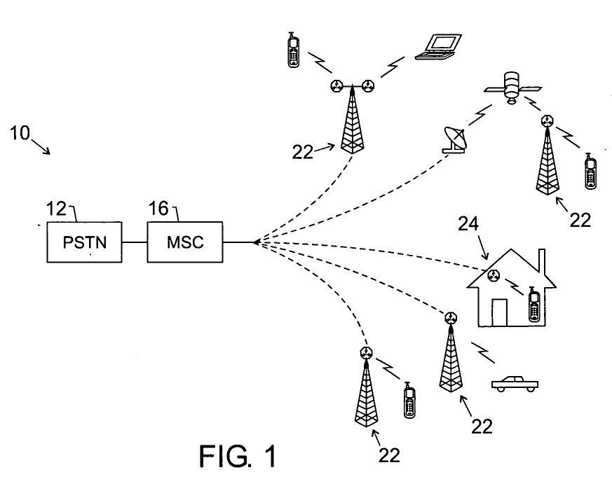

Turning now to the drawings, and referring initially to FIG. 1, an example of a telecommunication infrastructure for use in accordance with the present technique is illustrated and generally referred to by a reference numeral 10. In this example, the telecommunication infrastructure 10 includes a public switched telephone network (PTSN) 12, which is often referred to as a land-line telephone network. The PSTN 12 may be connected to a wireless system maintained by a service provider so that calls may be completed between subscribers to the wireless service provider and users of the land-line telephone network. Typically the PSTN 12 is connected to a wireless system at a mobile switching center (MSC) 16, which coordinates communication between the wireless system and the PSTN 12.

The MSC 16 is the switch that serves the wireless system, and it performs the function of switching calls to the appropriate destination and maintaining the connection. Indeed, the primary purpose of the MSC 16 is to provide a voice path connection between a mobile telephone and another telephone, such as another mobile telephone or a land-line telephone. A typical MSC 16 includes a number of devices that control switching functions, call processing, channel assignments, data interfaces, tracking, paging, call hand-off, billing, and user data bases.

To communicate with subscribers to the wireless system, the MSC 16 is typically coupled to multiple base transceiver stations via a fixed network. It should be understood that a transceiver may take any suitable form. For example, the transceiver may include antennas mounted on a tower 22 or the transceiver may include a building mounted antenna 24. Furthermore, the transceiver may communicate voice and/or data with any suitable communications device, such as portable cellular telephones, PDA's, vehicles having mobile cellular telephones and/or navigation systems, computer systems having wireless modems, and/or satellite systems.

As one might expect, as the prevalence of wireless devices increases within an area, the demands placed upon the respective MSC 16 and the supporting infrastructure increase as well. It is, therefore, not uncommon for a new MSC 16 to be constructed or for an existing MSC 16 to be updated with new equipment to provide additional capacity. In addition, an MSC 16 may be built or upgraded to incorporate support for a new or changed telecommunication standard to facilitate communication between different service providers, countries, or other entities connected to the telecommunication infrastructure 10. One example of this may be upgrading or designing an MSC 16 to support a global telecommunication standard, such as common channel signaling system number 7 (known herein as SS7).

The SS7 standard defines procedures and protocols by which network elements of the PSTN 12 exchange information over a digital signaling network to achieve setup, routing, and control of wireless and wireline calls. To perform these functions, an SS7 network may rely on a variety of network elements, known as signaling points, which exchange information over interconnecting signaling links. It may, therefore, be desirable for an MSC 16 to be able to receive and send data in accordance with a network implementing the SS7 standard, such as the PSTN 12. However, because of the number and complexity of the operations performed by the MSC 16, it may be difficult to assess the performance, efficiency and/or sufficiency of a proposed upgrade or design.

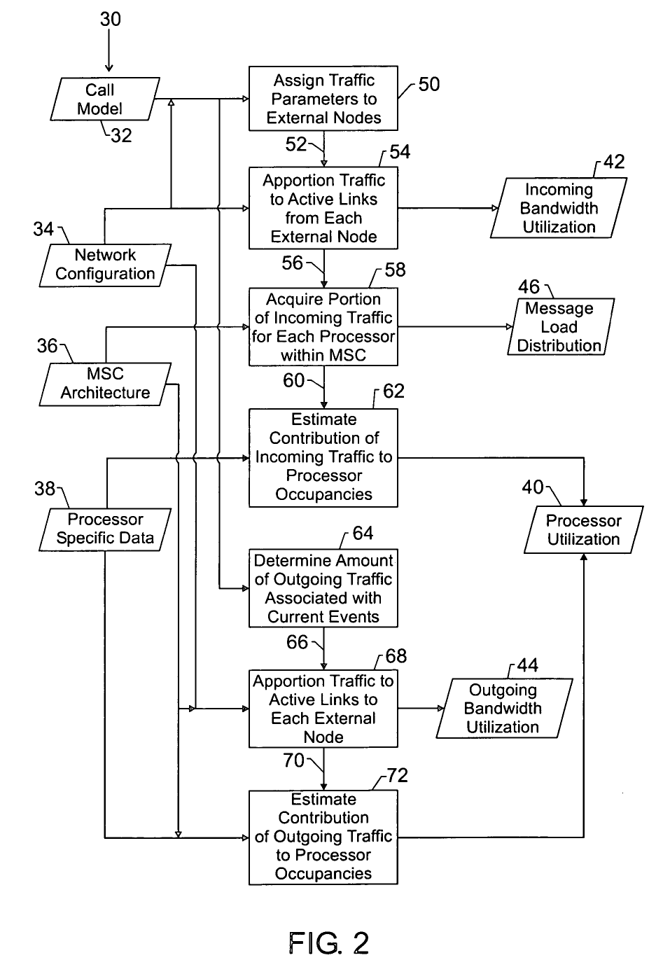

One possibility is to model the proposed design or upgrade and to assess the efficiency and/or sufficiency based on the model. For example, referring to FIG. 2, a flowchart depicting one possible modeling approach is provided. While the depicted approach is presented in the context of modeling the constituents of an MSC 16 in communication with an SS7 network, the present modeling techniques are also applicable in contexts where other network standards are employed or where an MSC 16 is not the facility of interest.

As depicted in the model, a variety of inputs 30 may be provided by user selection or based on constraints built into the model. For example, a call model 32 may be provided to the model. In general, the call model 32 provides the logical load properties for the model, i.e., the message traffic to be simulated across the network components of the MSC 16. The call model 32 may represent a wide range of variables and granularity and may be changed interactively to represent variable load conditions or hypothetical scenarios.

The call model 32 may be defined by a variety of traffic source parameters. For example, total busy hour call attempts (BHCA), message events, and average message size may be calculated for a wide range of load requirements to provide a variety of call models 32. The call model 32 may represent the various traffic parameters as the amount of traffic exchanged over the network links measured in message signal units (MSU's), which represent a basic piece of information, as defined by the relevant protocol.

In addition, the call model 32 may provide for different types of network traffic that may be received by the MSC 16. For example, the MSC 16 may receive or send traffic to multiple external nodes, such as signal transfer points (STP's) on an SS7 network or a proprietary electronic switching system (ESS), such as a 5ESS® system. The call model 32 may, therefore, provide for different traffic loads corresponding to a range of available traffic types.

Furthermore, the call model 32 may also provide for events, associated with some or all of the messages, which represent actions that must be performed by a processor in the MSC network upon receipt of the simulated message. For instance, a registration notification event, as may occur when a subscriber transitions between coverage areas, may be performed for a specified percentage of the simulated message load. The call model 32, therefore, provides the various traffic conditions and requirements that the model operates under for a particular simulation.

Another input to the exemplary model of FIG. 2 is a network configuration 34, such as an SS7 network configuration, which governs communication to and from the MSC 16. Typically the network configuration 34 will be input by an operator based on the network being modeled. In particular, the operator will typically specify the components of the network to be modeled as well as the links between respective components. For example, to develop an MSC model in an SS7 network environment, the operator might specify the processor-based components of the MSC 16, such as direct link nodes (DLN), call processing/database nodes (CDN), and a home/visitor location register (HVLR). In addition, the operator may specify the signaling termination components external to the MSC 16, such as one or more STP's or ESS's, which send incoming message traffic to the MSC 16 and receive outgoing message traffic from the MSC. As one of ordinary skill in the art will appreciate modeled external components, i.e., STP's and/or ESS's, may correspond to a node of the PSTN 12 or a transceiver base station in communication with the MSC 16.

In addition, the operator may specify the links between the components of the modeled network. Typically, the various processor-based components of the MSC 16, i.e., the internal network components, may be assumed to be linked via an internal high-speed network, such as a fault tolerant local area network (FT-LAN). However, traffic from the signaling termination components external to the MSC 16 may be directed to specific components of the MSC 16, such as to specific DLN's, via a fixed line. Similarly, outgoing traffic from the MSC 16 may be directed through specific DLN's to the external node via the line. The operator may, therefore, specify which processor-based components of the MSC 16 are linked to which signaling termination components and the characteristics, such as bandwidth and communication protocols of each link. The network configuration 34, therefore, provides a description of what links are present between the network components external to and internal to the MSC 16 and what communication standards govern the usage of these links.

The preceding two inputs describe the traffic load to be simulated by the model, i.e., the call model 32, and the network links over which the simulated traffic load flows to and from the MSC 16 from various external sources, i.e., the network configuration 34. The MSC architecture 36 typically includes the rules for distributing the traffic between the MSC components, i.e., between the different processors within the MSC 16 available for handling the simulated traffic load. Unlike the call model 32 and the network configuration 34, the MSC architecture 36 may not be configurable or may be only partially configurable by the operator. Instead the all or part of the MSC architecture 36 may be stipulated by the modeling software or routines to account for the invariance of these rules in practice. In other words, if the aspects of the distributive rules underlying the MSC architecture 36 are generally invariable at the MSC 16, the model may be configured with a MSC architecture 36 which reflects the degree of invariance.

An example of an invariant component of the MSC architecture 36 may be the loadsharing of a given event between legacy processor and more modern processors, such as between the call processing/database nodes (CDN's) present on a legacy network and on a more recent network. In such an example, the MSC architecture 36 may include an invariant component that reflects the ratio of the processing powers of the legacy and the newer processors. Other invariant components may also be included in the MSC architecture to reflect other aspects of the network architecture that are generally or conceptually invariable.

Conversely, some components of the MSC architecture 36 may be configurable by an operator to reflect allowable variation in a network implementation. For example, simulated events included in the call model 32 may be associated with some or all of the MSC processors based on their processing costs with the respective processors. In this way, the processing path of each event may be defined such that, for each event, the MSC architecture 36 contains the necessary information to determine what processor will handle the event. Such a processing path is one example of an architectural definition that may be configurable by an operator. As will be appreciated by one of ordinary skill in the art, the different variable and invariable components of the MSC architecture 36 may vary based on the underlying network being modeled or designed.

An additional input to the exemplary model depicted in FIG. 2 provides processor specific data 38. The processor specific data 38 may include lab results or other performance measures of the actual processor-based components represented in the model. Alternatively, the processor specific data 38 may be hypothetical, allowing the sufficiency or fault tolerance of a proposed network configuration to be tested. In general, the processor specific data 38 reflects the throughput of the processors handling message traffic in the MSC 16 once the messages have been distributed by the MSC architecture.

For example, the processor specific data 38 may reflect historical performance data or laboratory data for each DLN simulated in the model. While the lab results or historical data may reflect the performance of individual processor-based components, it may also reflect the performance of different classes of components, such as different models of DLN, different processor types, and so forth. In other words, the information provided as processor specific data 38 may vary depending on the desired degree of specificity. Regardless, to the extent that a DLN or other processor-based component is modeled, the model may reflect the known or hypothetical performance of the component based on the provided processor specific data 38.

For example, processor specific data 38 may be provided for each modeled DLN of the MSC 16. The processor specific data 38 may, therefore, include a reference indicator associating the data with a modeled processor as well as a rating, such as the maximum numbers of messages per second, for the modeled processor. In addition, the processor specific data 38 may include information about whether the modeled processor is linked to other networks, such as a legacy network, and, if so, the type of network connection supported by the processor. The processor specific data 38 may be configurable by the operator to simulate a failure of the processor for fault tolerance analyses. The processor specific data 38 may also be configured by the operator to indicate whether a particular DLN is to be monitored during a particular simulation.

These various inputs 30 may be used to model various aspects of network performance, such as processor utilization 40, bandwidth utilization 42, 44, and/or message load per processor 46. One exemplary routine for modeling these aspects of network performance based on the inputs 30 is provided in FIG. 2. As one of ordinary skill in the art will appreciate, the different acts described in implementing the exemplary routine may be performed in the sequence described or other sequences. Similarly, some acts described herein may be omitted to the extent that one or more aspects of network performance may not be of interest to an operator.

However, for the purpose of our example, the act of assigning traffic parameters to external nodes (traffic assignment act 50) is first discussed. The traffic assignment act 50 may assign traffic parameters, such as message per second, message sizes, and message type, to the external nodes, such as ESS's or STP's, connected to the MSC 16 being modeled. As will be appreciated, the traffic parameters may be determined from the call model 32 while the number and type of external nodes may be determined from the network configuration 34.

The resulting distribution 52 of messages among the external nodes may be apportioned between the active links associated with each external node to simulate incoming message traffic to the MSC 16 (incoming apportionment act 54). The incoming traffic portion assigned to each link may be determined by the governing protocol, such as SS7, which may be determined from the network configuration 34. The apportionment of incoming MSC message traffic to the respective active links, in accordance with the governing protocols, may provide the incoming bandwidth utilization 42 for each link.

The simulated incoming traffic 56 may then be acquired by the respective processors connected to the active links and distributed among the modeled processors according to the rules of the MSC architecture 36 (incoming traffic distribution act 58). The distribution of incoming traffic among the modeled processors may provide the load or message distribution 46 for each processor.

The resulting distribution 60 of messages among the modeled processors may be used to estimate the contribution of the incoming message traffic to the occupancy of each processor (incoming contribution estimation act 62). In particular, the message load on a processor in conjunction with the processor specific data 38 may be utilized to determine processor utilization 40 attributable to the simulated incoming traffic for each processor.

In addition, the amount of outgoing traffic handled by the MSC 16 may be determined based upon the traffic load events described by the call model 32 (outgoing traffic determination act 64). The outgoing message traffic 66 may be directed to the appropriate processors based on the MSC architecture 36 and apportioned among the active links to the desired external nodes (outgoing apportionment act 68). In particular, the outgoing message traffic 66 assigned to each link may be determined by the governing protocol, such as SS7, which may be determined from the network configuration 34. The apportionment of outgoing message traffic 66 to the respective active links, in accordance with the governing protocols, may provide the outgoing bandwidth utilization 44 for each link.

Based on the outgoing message load 70 on each processor, as determined by the outgoing apportionment act 68, contribution of the outgoing message traffic to the occupancy of each processor may be estimated (outgoing contribution estimation act 72). In particular, the outgoing message load 70 on a processor in conjunction with the processor specific data 38 may be utilized to determine processor utilization 40 attributable to the simulated outgoing traffic for each processor. In addition, additional processing costs associated with network overhead may be determined based on the MSC architecture 36 and may contribute to the processor utilization 40.

The various outputs of the model, such as processor utilization 40, bandwidth utilization 42, 44, and/or message load distribution 46, may be of use to a process or performance engineer in evaluating a network configuration or design for an MSC 16. In addition, more complex network designs, such as those incorporating legacy systems, may also be modeled in accordance with the present technique. For example, message load distribution 46 and processor utilization 40 for legacy processor-based components may be determined in the manner described above using the appropriate inputs for the architecture 36 and processor specific data 38. For example, the MSC architecture 36 may specify the rules governing the distribution of messages to the legacy processor components while the processor specific data 38 may specify the performance of the legacy processor components at the simulated traffic load.

As will be appreciated by those of ordinary skill in the art, the exemplary model depicted in FIG. 2 may be implemented in a variety of ways. For example a general purpose device, such as a general purpose workstation or server, may be configured to execute installed routines implementing the modeling techniques described herein. Alternately, a special purpose device such as a dedicated modeling station employing ASIC's or special purpose processors, may be employed to implement the present modeling technique.

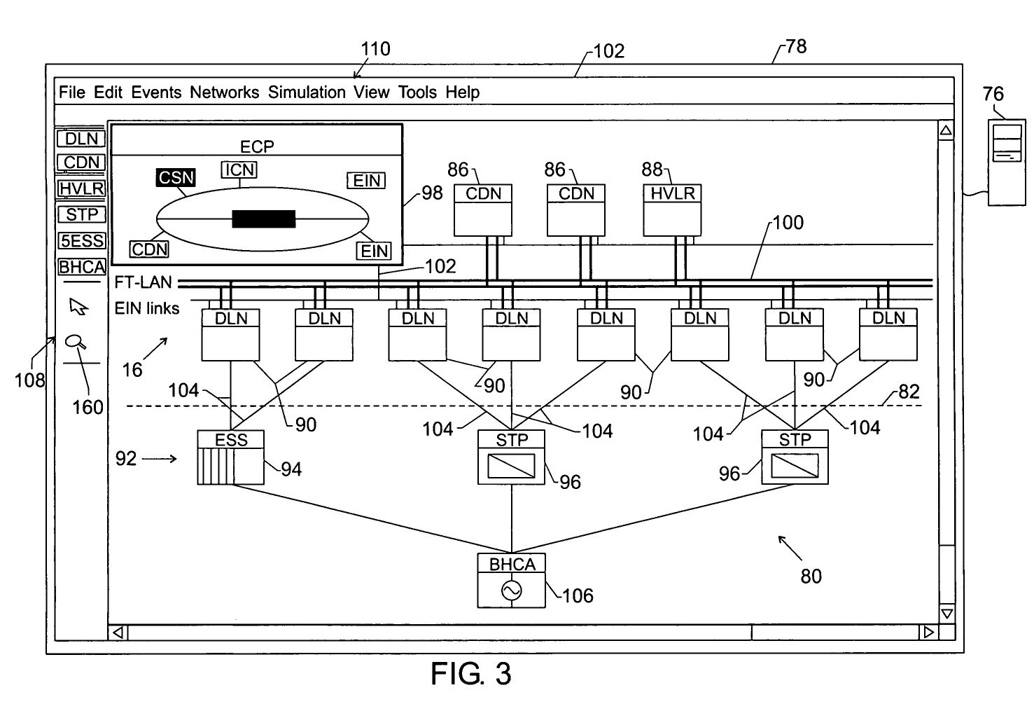

By way of example, FIGS. 3-6 are provided depicting one possible implementation of the present modeling technique on a computer 76, such as a general or special purpose computer, equipped with a display 78. In this example, the depicted implementation employs a graphical user interface (GUI). As one of ordinary skill in the art will appreciate, other interfaces may be employed, such as a tabular or textual interface.

Turning now to FIG. 3, a network model 80 is depicted. The network model 80 may incorporate representations of the various processor-based components of an MSC 16 (depicted above the dotted line 82), including call processing/database nodes (CDN) 86, home/visitor location registers (HVLR) 88, and direct link nodes (DLN) 90. In addition, signaling termination components 92 external to the MSC 16, such as electronic switching systems (ESS) 94 and signaling transfer points (STP) 96 are depicted. In addition, a legacy network 98 is depicted. The processor-based components of the MSC 16 are interconnected via a FT-LAN 100. The depicted legacy network 98 is connected to the other processor-based components of the MSC 16 via another network, here depicted as an ethernet network 102 possessing ethernet interface nodes.

Conversely, the signaling termination components 92 external to the MSC 16 each connect to respective DLN's 90 within the MSC 16 via links 104, which may represent fixed lines through which SS7 traffic passes. In addition, the model 80 depicts a traffic generator 106 connected by logical lines to the respective signaling termination components, i.e., the STP's 96 and the ESS 94. The traffic generator 106 represents a generalized source and destination of message traffic in the model.

In the depicted implementation, the various components of the MSC network, the signaling termination components 92, and the interconnecting links 104 may be added, deleted, and positioned by an operator via the GUI interface. For example, input devices such as mice, keyboards, touchscreens, light pens, and so forth, may be used to add or delete components and/or links 104. For example, an input device may be used to select a representation from a tool bar 108 or from a menu bar 110 which may be selectively interacted with to open an appropriate menu. The selected representation may then be added to the network model 80, such as by dragging and dropping the representation onto the work area. Similarly, an input device may be utilized to move one or more representations within the network model 80, such as by selecting a representation and dragging the representation to a new location. A representation may be similarly deleted, such as by selecting the representation using an input device and by selecting a deletion action from a menu, such as from the menu bar 110, or from an input device such as a keyboard.

Similarly, links 104 between the respective DLN's 90 and signaling termination components 92 may be established using an input device. For example, the links 104 may be added by the operator, such as by tracing a line signifying a link between two components or by selecting a link representation from a menu or from the tool bar 108 and dragging the ends of the link 104 to the respective components to be connected. In addition, the characteristics of each link 104, such as bandwidth and/or associated network protocol may be specified by the operator when the links 104 are placed in the network model 80. For example, the operator may be able to access a pop-up or dialog box via an input device (such as by double-clicking or right-clicking on a link 104). The pop-up or dialog box may allow for the entry of the characteristics of the respective link. Alternatively, a suitable link 104 having the desired characteristics may be selectable from the tool bar 108 or menu bar 110. In this way, a link 104 having the desired characteristics may be selected and added to the network model 80.

In this manner, a network model 80 may be generated by an operator adding and positioning the desired components and links 104 of the network being modeled. Furthermore, the network model 80 constructed in this manner may serve as the network configuration 34 input of the model depicted in FIG. 2. In other words, the network model 80 constructed by the operator specifies and characterizes the links 104 between the external signaling termination components 92 and the MSC 16, which equates to the network configuration 34 input depicted in the model of FIG. 2.

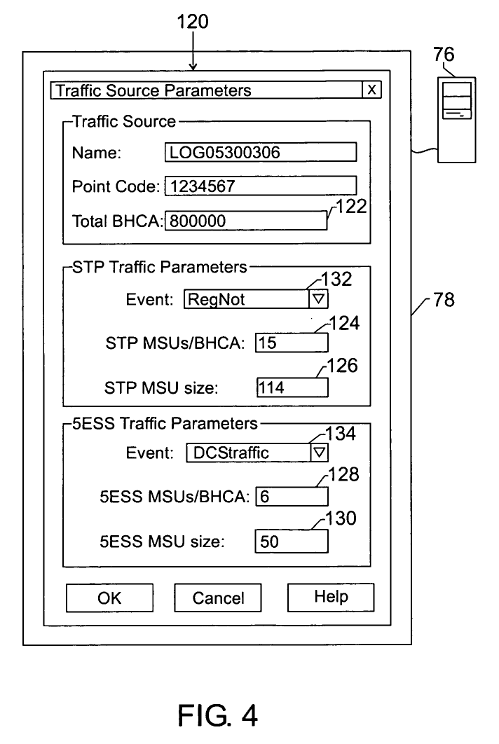

The operator may also specify the other configurable inputs used by the exemplary modeling technique of FIG. 2 via the GUI interface. For example, the call model 32 may be constructed by operator interaction with the traffic generator 106. Referring now to FIG. 4, a traffic source parameters screen 120 may be accessed, such as by interacting with the traffic generator 106 representation with an input device (mouse, keyboard, etc.). The values provided in the various fields of the traffic source parameters screen 120 may define the call model 32. For example, a Total BHCA field 122 may be provided in which the entered value represents the total call or message attempts in an hour. In addition, for an SS7 network, a field 124 may be provided to specify the message signal units (MSU) per BHCA which are handled by the STP's 96 represented in the model, i.e., the number of messages associated with the specified call attempts which are to be handled by STP's 96. The size of the MSU's handled by the STP's may also be specified, such as at a STP MSU size field 126. Similarly, respective fields 128, 130 may be provided for MSU/BHCA and MSU size related to non-SS7 traffic, such as might be handled by a proprietary ESS 94.

In addition, events associated with different types of message traffic, such as registration notification, may be specified such as at STP event field 132 and ESS event field 134. Upon completion of these various fields, the desired call model 32 may be implemented in the simulation, such as via simulated traffic generated by the traffic generator 106. While specific data fields for specifying aspects of the call model 32 related to the type, quantity, and size of messages have been depicted in this example, other message traffic variables or descriptors that define a desired call model 32 may be employed and are within the scope of the present technique.

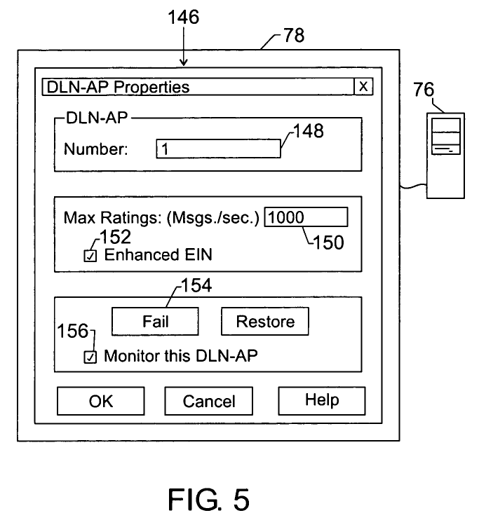

While FIGS. 3 and 4 depict exemplary screens that may be used to provide network configuration 34 and call model 32 information respectively, FIG. 5 depicts an exemplary screen for inputting processor specific data 38. For example, in the depicted model, an operator may desire to enter processor specific data 38 for each DLN 90 of the modeled MSC 16. The operator may access a DLN properties screen 146 for each DLN 90, such as by interacting with each desired DLN 90 representation with an input device (mouse, keyboard, etc.). The values provided in the accessed DLN properties screen may define the processor-specific data 38 utilized by the model.

For example, an identifier field 148 may be provided which allows the input data to be associated with a particular processor, i.e., DLN 90. Another field 150 may allow the input of a maximum rating, measured as messages per second, for the specified processor. The maximum rating may be based on a hypothetical scenario postulated by the operator, historical data obtained from operation of the processor to be modeled, or from lab data performed on the processor. In addition, network connections of the processor that may impact processor performance, such as connection to a legacy network 98, may be noted on the DLN properties screen 146, such as at enhanced EIN check box 152.

In addition, other aspects of processor behavior specific to the simulation may be set at the DLN properties screen 146 for each processor. For example, a specific processor, represented here as a DLN 90, may be configured to fail in a simulation, such as by toggling the fail button 154. Similarly, the type or degree of monitoring associated with a processor or link may be configurable, such as by selection of the monitor check box 156. Upon entry of these various inputs for each represented processor, in this case represented as DLN's 90 of the network model 80, the desired processor-specific data 38 may be utilized in one or more simulations. As will be appreciated by those of ordinary skill in the art, other processor-specific data 38 may be input and relied upon than that described in the present example without being outside the scope of the present technique.

Once the desired network configuration 34, call model 32, and processor-specific data 38 have been entered, such as via exemplary network model 80, traffic source parameters screen 120, and DLN properties screens 146, a simulation may be executed. For example, on the network model screen the simulation may be initiated by the selection of the appropriate menu option or tool bar button. Upon execution of a simulation, the impact of the call model 32 on the configured network model 80 may be assessed with output updates being provided at a desired time increment, such as every second. In particular, various outputs of the model, such as the exemplary model depicted in FIG. 2, may be displayed in conjunction with the network model 80.

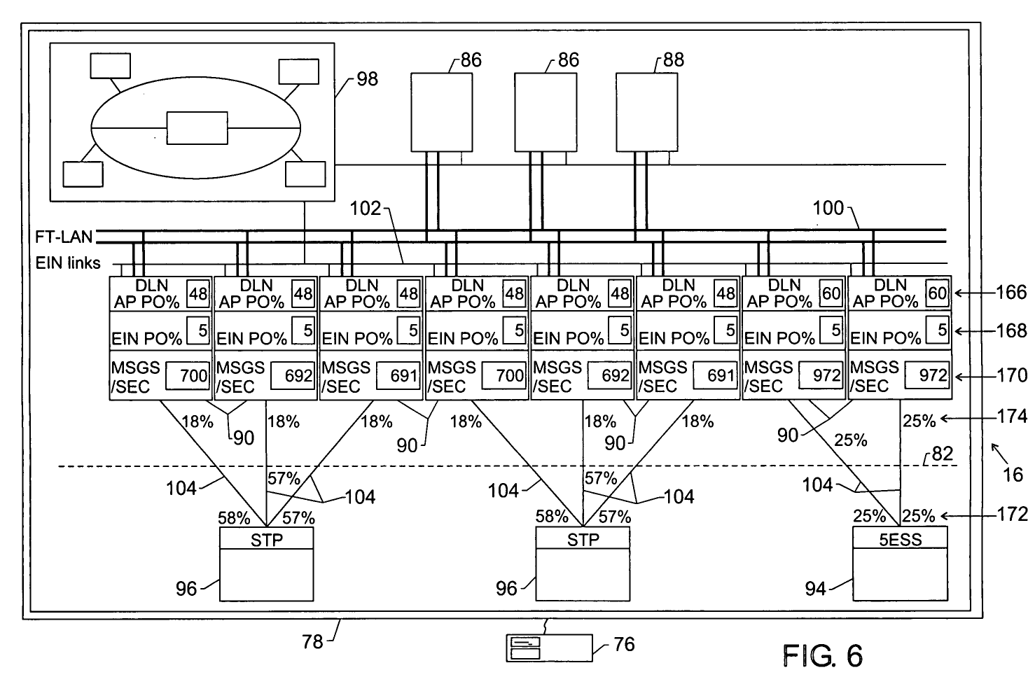

For example, referring to FIG. 6, each modeled DLN 90 is depicted in conjunction with the associated model outputs. In particular, each DLN 90 is depicted with an associated advanced processor occupancy (AP PO %) 166 and ethernet interface node processor occupancy (EIN PO %) 168. As will be appreciated by those of ordinary skill in the art, the AP PO % 166 and EIN PO % 168 may be based on the processor utilization 40 derived from the exemplary model of FIG. 2. The EIN PO % 168 may be simulated and output if the provided processor-specific data 38 indicates a connection to a legacy network 98, as may be indicated at EIN check box 152 of the DLN properties screens 146. In particular, the EIN PO % 168 may illustrate the portion of processor utilization 40 associated with the overhead incurred in supporting the legacy network 98. In addition, for each processor the message load 170, here depicted as messages per second, may be provided as an output. The various displayed message loads 170 may be based on the message load distribution 46 output from the exemplary model of FIG. 2.

In addition to information concerning the utilization of the processors, information may also be displayed regarding the utilization of the links 104. In particular, incoming bandwidth utilization 172, representing message traffic coming into the MSC 16, may be depicted on each respective link and may be derived from the incoming bandwidth utilization 42 output of the model. Similarly, outgoing bandwidth utilization 174 from the MSC 16 may be depicted on each link and may be derived from the outgoing bandwidth utilization 44 output of the model.

Furthermore, additional monitoring capabilities may be provided and accessed, such as via a monitor button or icon 160. The additional monitoring capabilities may facilitate evaluation of the simulated links 104 and processors. For example, a DLN 90 may be connected to a signaling termination component 92 via a multitude of links which may graphically be represented by a single line, here conceptualized as link 104. To allow inspection of the traffic distribution among these aggregated links, the monitor button 160 may be activated and the desired link representations selected to provide a graphic or textual breakdown of the distribution of message traffic over the simplified link representation. Similarly, the monitor function may be used to provide additional monitoring capabilities about simulated MSC processors, such as CDN 86, HVLR 88, and DLN 90. For example, a breakdown of the processing costs of incoming and outgoing events on a per processor basis may be provided upon activation of the monitoring function and selection of a processor.

In this way, the multitude of processors and links 104 of a network may be simultaneously modeled to generate a wide array of information that may be useful to an operator or engineer. For example, an operator may be provided with output related to processor utilization and/or bandwidth utilization for a particular network configuration under traffic conditions of interest. New or alternative configurations may then analyzed and compared such that a configuration having the desired efficiency and/or sufficiency may be selected. Such a configuration may then be considered when upgrading an existing MSC 16 or when designing a new MSC 16, thereby allowing resources to be employed efficiently based on the predicted message traffic.

It should be understood that the modeling techniques described herein may be implemented through software, hardware, or any suitable combination thereof. Furthermore, it is contemplated that the modeling techniques discussed herein may be implemented on a general purpose device, such as a general purpose server or workstation, with the appropriate software programming to carry out these techniques. Alternatively, may be implemented on a special purpose device, such as a special purpose workstation employing special purpose processors and/or software to carry out these techniques.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for modeling a communication system, comprising the steps of:
assigning a plurality of simulated messages to one or more simulated external nodes based upon at least a simulated call model and a simulated network configuration;
distributing the plurality of simulated messages between a plurality of simulated active links connecting the one or more simulated external nodes to a plurality of simulated processors of a simulated telecommunication facility based on at least the simulated network configuration;
distributing the plurality of simulated messages between the plurality of simulated processors based on at least a simulated network architecture;
generating a plurality of simulated outgoing messages based upon at least the plurality of simulated messages and the simulated call model; and
distributing the plurality of simulated outgoing messages between the plurality of simulated active links based on at least the simulated network configuration and the simulated network architecture.

2. The method, as set forth in claim 1, comprising the step of:
estimating a contribution to processor occupancy for one or more processors of the plurality of simulated processors based on at least one of the plurality of simulated messages, the plurality of simulated outgoing messages, a set of processor specific data, and the simulated network architecture.

3. The method as set forth in claim 2, comprising the step of:
deriving a processor utilization for one or more processors of the plurality of simulated processors based on the respective contributions to processor occupancy.

4. The method, as set forth in claim 1, comprising the step of:
deriving a bandwidth utilization for one or more links of the plurality of simulated active links based on at least one of the distribution of the plurality of simulated messages between the one or more simulated active links and the distribution of the plurality of simulated outgoing messages between the one or more simulated active links.

5. The method, as set forth in claim 1, comprising the step of: deriving a message load distribution based on at least the distribution of the plurality of simulated messages between the one or more respective simulated processors.

6. The method, as set forth in claim 1, wherein the simulated telecommunication facility represents a mobile switching center.

7. The method, as set forth in claim 1, wherein the one or more simulated external nodes represent at least one of a signal transfer point and an electronic switching system.

8. The method, as set forth in claim 1, wherein one or more of the plurality of simulated processors represent at least a direct link node.

9. The method as set forth in claim 1, wherein the one or more of the plurality of simulated processors represent components of a legacy network.

10. The method, as set forth in claim 1, comprising the step of:
constructing a mobile switching center based on the simulated network configuration, wherein the simulated network configuration results in at least one of a desired distribution of the plurality of simulated messages between the plurality of simulated active links, a desired distribution of the plurality of simulated messages between the plurality of simulated processors, and a desired distribution of the plurality of simulated outgoing messages between the plurality of simulated active links.

11. The method, as set forth in claim 1, comprising the step of:
upgrading a mobile switching center based on the simulated network configuration, wherein the simulated network configuration results in at least one of a desired distribution of the plurality of simulated messages between the plurality of simulated active links, a desired distribution of the plurality of simulated messages between the plurality of simulated processors, and a desired distribution of the plurality of simulated outgoing messages between the plurality of simulated active links.

12. The method, as set forth in claim 1, comprising the step of:
procuring a processor-based component based on the simulated network configuration, wherein the simulated network configuration results in at least one of a desired distribution of the plurality of simulated messages between the plurality of simulated active links, a desired distribution of the plurality of simulated messages between the plurality of simulated processors, and a desired distribution of the plurality of simulated outgoing messages between the plurality of simulated active links.

13. The method, as set forth in claim 1, comprising the step of:
constructing a link based on the simulated network configuration, wherein the simulated network configuration results in at least one of a desired distribution of the plurality of simulated messages between the plurality of simulated active links, a desired distribution of the plurality of simulated messages between the plurality of simulated processors, and a desired distribution of the plurality of simulated outgoing messages between the plurality of simulated active links.

14. A tangible, machine readable media, comprising:
code adapted to assign a plurality of simulated messages to one or more simulated external nodes based upon at least a simulated call model and a simulated network configuration;
code adapted to distribute the plurality of simulated messages between a plurality of simulated active links connecting the one or more simulated external nodes to a plurality of simulated processors of a simulated telecommunication facility based on at least the simulated network configuration;
code adapted to distribute the plurality of simulated messages between the plurality of simulated processors based on at least a simulated network architecture;
code adapted to generate a plurality of simulated outgoing messages based upon at least the plurality of simulated messages and the simulated call model; and
code adapted to distribute the plurality of simulated outgoing messages between the plurality of simulated active links based on at least the simulated network configuration and the simulated network architecture.

15. The tangible, machine readable media, as set forth in claim 14, comprising:
code adapted to estimate a contribution to processor occupancy for one or more processors of the plurality of simulated processors based on at least one of the plurality of simulated messages, the plurality of simulated outgoing messages, a set of processor specific data, and the simulated network architecture.

16. The tangible, machine readable media, as set forth in claim 15, comprising:
code adapted to derive a processor utilization for one or more processors of the plurality of simulated processors based on the respective contributions to processor occupancy.

17. The tangible, machine readable media, as set forth in claim 14, comprising:
code adapted to derive a bandwidth utilization for one or more links of the plurality of simulated active links based on at least one of the distribution of the plurality of simulated messages between the one or more simulated active links and the distribution of the plurality of simulated outgoing messages between the one or more simulated active links.

18. The tangible, machine readable media, as set forth in claim 14, comprising:
code adapted to derive a message load distribution based on at least the distribution of the plurality of simulated messages between the one or more respective simulated processors.

19. A device for modeling a communication system, comprising:
a processor configured to execute code adapted to:
assign a plurality of simulated messages to one or more simulated external nodes based upon at least a simulated call model and a simulated network configuration;
distribute the plurality of simulated messages between a plurality of simulated active links connecting the one or more simulated external nodes to a plurality of simulated processors of a simulated telecommunication facility based on at least the simulated network configuration;
distribute the plurality of simulated messages between the plurality of simulated processors based on at least a simulated network architecture;
generate a plurality of simulated outgoing messages based upon at least the plurality of simulated messages and the simulated call model; and
distribute the plurality of simulated outgoing messages between the plurality of simulated active links based on at least the simulated network configuration and the simulated network architecture.

20. The device, as set forth in claim 19, wherein the processor is configured to execute code adapted to:
estimate a contribution to processor occupancy for one or more processors of the plurality of simulated processors based on at least one of the plurality of simulated messages, the plurality of simulated outgoing messages, a set of processor specific data, and the simulated network architecture.

21. The device, as set forth in claim 20, wherein the processor is configured to execute code adapted to:
derive a processor utilization for one or more processors of the plurality of simulated processors based on the respective contributions to processor occupancy.

22. The device, as set forth in claim 19, wherein the processor is configured to execute code adapted to:
derive a bandwidth utilization for one or more links of the plurality of simulated active links based on at least one of the distribution of the plurality of simulated messages between the one or more simulated active links and the distribution of the plurality of simulated outgoing messages between the one or more simulated active links.

23. The device, as set forth in claim 19, wherein the processor is configured to execute code adapted to:
derive a message load distribution based on at least the distribution of the plurality of simulated messages between the one or more respective simulated processors.

24. The device, as set forth in claim 19, wherein the device comprises a general purpose computer.

25. The device, as set forth in claim 19, wherein the device comprises a special purpose computer.

26. A method for manufacturing a device for modeling a communication system, comprising the step of:
loading a computer program onto a device, wherein the computer program comprises:
code adapted to assign a plurality of simulated messages to one or more simulated external nodes based upon at least a simulated call model and a simulated network configuration;
code adapted to distribute the plurality of simulated messages between a plurality of simulated active links connecting the one or more simulated external nodes to a plurality of simulated processors of a simulated telecommunication facility based on at least the simulated network configuration;
code adapted to distribute the plurality of simulated messages between the plurality of simulated processors based on at least a simulated network architecture;
code adapted to generate a plurality of simulated outgoing messages based upon at least the plurality of simulated messages and the simulated call model; and
code adapted to distribute the plurality of simulated outgoing messages between the plurality of simulated active links based on at least the simulated network configuration and the simulated network architecture.

27. The method, as set forth in claim 26, wherein the device comprises a general purpose computer.

28. The method, as set forth in claim 26, wherein the device comprises a special purpose computer.
